(19) United States
(12) Patent Application Publication
(10) Pub. No.: US 2026/0184070 A1
(43) Pub. Date: Jul. 2, 2026

(54) LIQUID EJECTING APPARATUS

(71) Applicant: SEIKO EPSON CORPORATION, Tokyo (JP)

(72) Inventors: Takahiro KATAKURA, OKAYA-SHI (JP); Takanori AIMONO, SHIOJIRI-SHI (JP); Mitsuki EBISAWA, SHIOJIRI-SHI (JP)

(21) Appl. No.: 19/428,412

(22) Filed: Dec. 22, 2025

(30) Foreign Application Priority Data
Dec. 26, 2024 (JP) 2024-230023

(51) Int. Cl. B41J 2/045

(52) U.S. Cl. CPC B41J 2/04588; B41J 2/04541; B41J 2/04563; B41J 2/0457; B41J 2/04571; B41J 2/04581

(57) ABSTRACT

In a liquid ejecting apparatus, a drive signal includes an ejection pulse that ejects a droplet from a nozzle, the ejection pulse has a first contraction element that changes in potential by a first potential change amount, a first contraction maintaining element that maintains a terminal potential of the first contraction element, and a second contraction element that is coupled to a terminal end of the first contraction maintaining element and changes in potential by a second potential change amount, when a viscosity indicated by viscosity information is a first viscosity, a ratio of the first potential change amount to the second potential change amount is a first value, and when the viscosity indicated by the viscosity information is a second viscosity higher than the first viscosity, the ratio of the first potential change amount to the second potential change amount is a second value smaller than the first value.

The present application is based on, and claims priority from JP Application Serial Number 2024-230023, filed December 26, 2024, the disclosure of which is hereby incorporated by reference herein in its entirety.

### BACKGROUND

### 1. Technical Field

The present disclosure relates to a liquid ejecting apparatus.

### 2. Related Art

In a liquid ejecting apparatus typified by a piezoelectric ink jet printer, a drive signal is supplied to a piezoelectric element to generate pressure fluctuations in the liquid in a pressure chamber, thereby ejecting the liquid from a nozzle communicating with the pressure chamber. In such a liquid ejecting apparatus, the drive signal may be corrected in accordance with the viscosity of the liquid in order to suppress deterioration of the ejection characteristics caused by changes in the viscosity of the liquid. For example, JP-A-2012-20408 discloses a liquid ejecting apparatus that adjusts a potential change amount of a drive signal based on detection results of a temperature sensor that detects the temperature of the liquid in order to suppress deterioration of ejection characteristics caused by changes in viscosity due to changes in the temperature of the liquid.

The technology disclosed in JP-A-2012-20408 simply adjusts the potential change amount of the drive signal, and therefore, when the range of change in viscosity of the liquid becomes equal to or greater than a predetermined value, it may become difficult to maintain constant ejection characteristics.

### SUMMARY

According to an aspect of the present disclosure, there is provided a liquid ejecting apparatus including: an ejection portion having a nozzle for ejecting a liquid, a pressure chamber communicating with the nozzle, and a piezoelectric element that is driven to generate a pressure fluctuation in the liquid in the pressure chamber in response to a supplied drive signal; a drive signal generation circuit that generates the drive signal; an acquisition portion that acquires viscosity information indicating a viscosity of the liquid; and a control portion that controls an operation of the drive signal generation circuit, in which the drive signal includes an ejection pulse that ejects a droplet from the nozzle, the ejection pulse has a first contraction element that changes in potential by a first potential change amount to contract the pressure chamber, a first contraction maintaining element that is coupled to a terminal end of the first contraction element and maintains a terminal potential of the first contraction element, and a second contraction element that is coupled to a terminal end of the first contraction maintaining element and changes in potential by a second potential change amount to contract the pressure chamber, when the viscosity indicated by the viscosity information is a first viscosity, a ratio of the first potential change amount to the second potential change amount is a first value, and when the viscosity indicated by the viscosity information is a second viscosity higher than the first viscosity, the ratio of the first potential change amount to the second potential change amount is a second value smaller than the first value.

### BRIEF DESCRIPTION OF THE DRAWINGS

FIG. 1 is a schematic diagram illustrating a configuration example of a liquid ejecting apparatus according to a first embodiment.

FIG. 2 is a block diagram illustrating an electrical configuration of the liquid ejecting apparatus according to the first embodiment.

FIG. 3 is a cross-sectional view of a head.

FIG. 4 is a diagram illustrating a configuration example of a drive circuit.

FIG. 5 is an explanatory diagram of an ejection pulse and an inspection pulse included in a drive signal.

FIG. 6 is a flowchart illustrating a method for driving the liquid ejecting apparatus according to the first embodiment.

FIG. 7 is a diagram illustrating a relationship between a viscosity of a liquid and a ratio of potential change amounts of an ejection pulse.

FIG. 8 is an explanatory diagram of an ejection pulse when the viscosity indicated by viscosity information is a first viscosity.

FIG. 9 is an explanatory diagram of an ejection pulse when the viscosity indicated by viscosity information is a second viscosity.

FIG. 10 is an explanatory diagram of an ejection pulse when the viscosity indicated by viscosity information is a third viscosity.

FIG. 11 is an explanatory diagram of another example of an ejection pulse when the viscosity indicated by viscosity information is the third viscosity.

FIG. 12 is an explanatory diagram of an ejection pulse when the viscosity indicated by viscosity information in a second embodiment is a first viscosity.

FIG. 13 is an explanatory diagram of an ejection pulse when the viscosity indicated by viscosity information in the second embodiment is a second viscosity.

FIG. 14 is an explanatory diagram of an ejection pulse when the viscosity indicated by viscosity information in the second embodiment is a third viscosity.

FIG. 15 is an explanatory diagram of another example of an ejection pulse when the viscosity indicated by viscosity information in the second embodiment is the third viscosity.

### DESCRIPTION OF EMBODIMENTS

Hereinafter, preferred embodiments according to the present disclosure will be described with reference to the accompanying drawings. In the drawings, the dimensions and scale of each portion are appropriately different from the actual ones, and some portions are schematically illustrated for easy understanding. Further, the scope of the present disclosure is not limited to the embodiments unless it is stated in the following description that the present disclosure is particularly limited.

In the following description, for the sake of convenience of specifying a position, direction, or the like, an X-axis, a Y-axis, and a Z-axis that intersect each other are appropriately used. In the following, one direction along the X-axis is an X1 direction, and a direction opposite to the X1 direction is an X2 direction. Similarly, the directions opposite to each other along the Y-axis are a Y1 direction and a Y2 direction. Directions opposite to each other along the Z-axis will be referred to as a Z1 direction and a Z2 direction.

Here, typically, the Z-axis is a vertical axis, and the Z2 direction corresponds to a downward direction in the vertical direction. Meanwhile, the Z-axis need not be the vertical axis. The X-axis, the Y-axis, and the Z-axis are typically orthogonal to each other, but are not limited thereto, and only need to intersect each other at, for example, an angle within a range of, for example, 80° or more and 100° or less.

### A: First Embodiment

### A1: Overall Configuration of Liquid Ejecting Apparatus

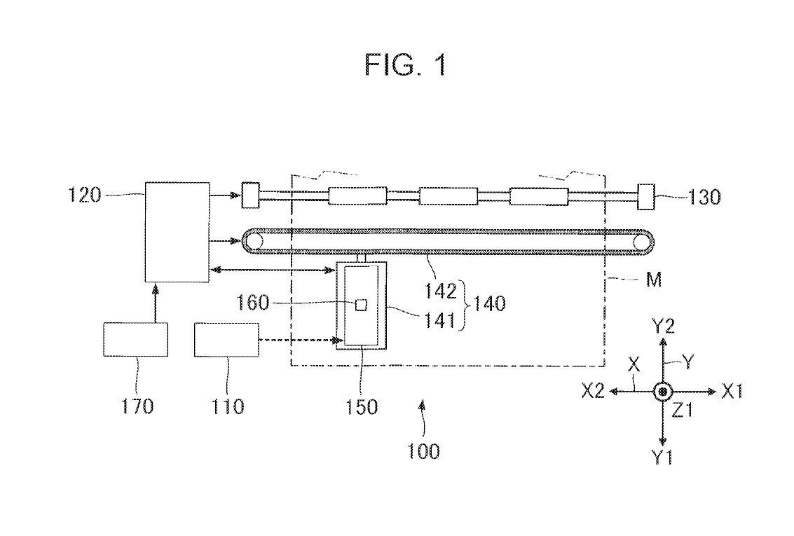

FIG. 1 is a schematic diagram illustrating a configuration example of a liquid ejecting apparatus 100 according to a first embodiment. The liquid ejecting apparatus 100 is an ink jet printing apparatus that ejects ink, which is an example of a “liquid”, onto a medium M as a droplet. The medium M is, for example, printing paper. The medium M is not limited to the printing paper and may be, for example, any material that is a printing target such as a resin film or fabric.

As illustrated in FIG. 1, the liquid ejecting apparatus 100 includes a liquid container 110, a control module 120, a transport mechanism 130, a moving mechanism 140, a head module 150, a temperature sensor 160, and an input device 170.

The liquid container 110 stores ink. Specific aspects of the liquid container 110 include, for example, a cartridge that can be attached to and detached from the liquid ejecting apparatus 100, a bag-shaped ink pack formed of a flexible film, and an ink tank that can be refilled with ink. The type of ink stored in the liquid container 110 is optional.

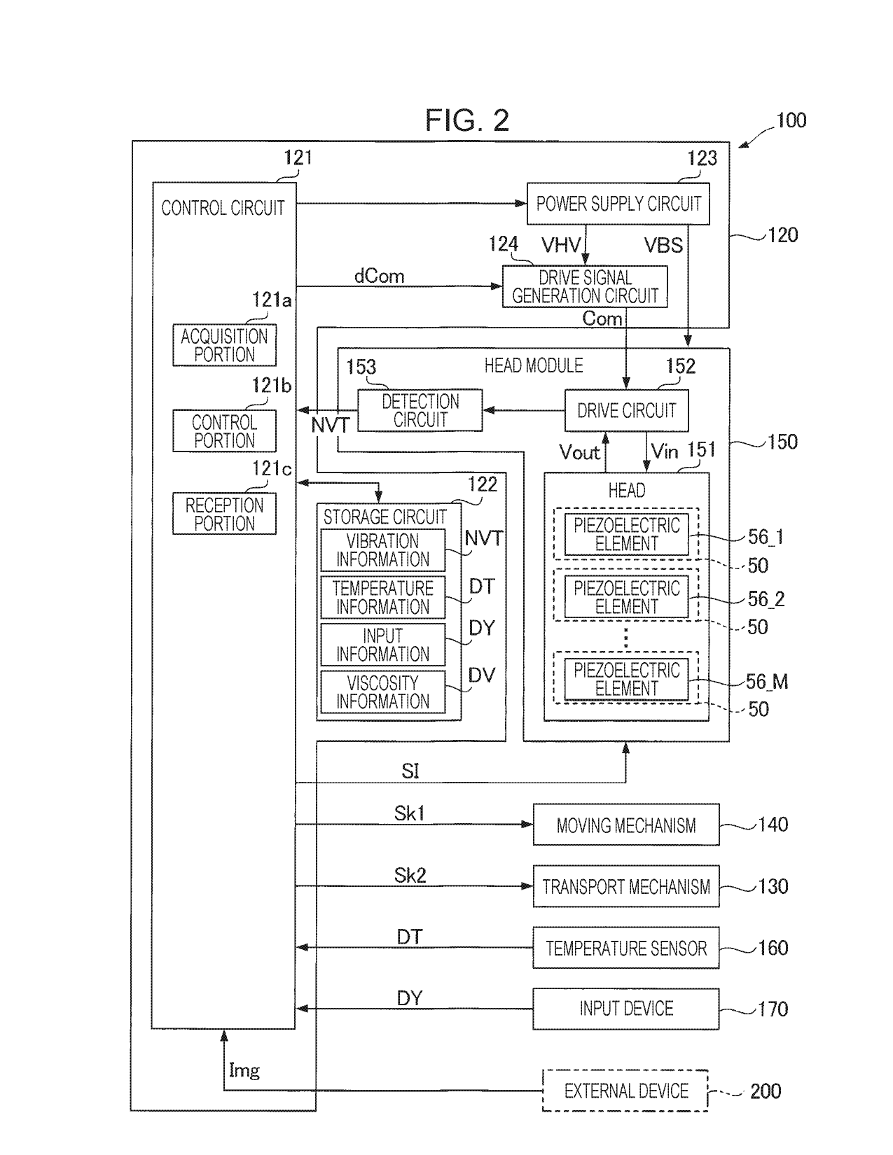

The control module 120 controls the operation of each element in the liquid ejecting apparatus 100. Details of the control module 120 will be described below with reference to FIG. 2.

The transport mechanism 130 transports the medium M along the Y-axis under the control of the control module 120.

The moving mechanism 140 reciprocates the head module 150 along the X-axis under the control of the control module 120. The moving mechanism 140 has a substantially box-shaped transport body 141 called a carriage that accommodates the head module 150, and an endless transport belt 142 to which the transport body 141 is fixed. The number of head modules 150 mounted on the transport body 141 is not limited to one, but a plurality of head modules may be provided. In addition to the head module 150, the above-described liquid container 110 may be mounted on the transport body 141.

The head module 150 ejects ink supplied from the liquid container 110 onto the medium M from each of the plurality of nozzles under the control of the control module 120. The ink is simultaneously ejected when the medium M is transported by the transport mechanism 130 and the head module 150 is caused to reciprocate by the moving mechanism 140. In this manner, an image is formed at a surface of the medium M by using the ink.

The temperature sensor 160 detects the temperature. More specifically, the temperature sensor 160 is a resistance temperature sensor such as a linear resistor or a thermistor, and detects the temperature of ink in a pressure chamber C, which will be described later. In the example illustrated in FIG. 1, the temperature sensor 160 is installed in the head module 150. The installation position of the temperature sensor 160 is not limited to the example illustrated in FIG. 1, and may be a position where the temperature of the ink in the pressure chamber C, which will be described below, can be directly detected, or a location where detection results that can estimate the temperature of the ink in the pressure chamber C, which will be described below, can be acquired, and is not particularly limited. Further, the temperature sensor 160 is not limited to a resistance temperature sensor, but may be an optical temperature sensor.

The input device 170 is a device that receives an input from a user and outputs input information DY based on the input from the user. For example, the input device 170 includes an operation panel or a remote control light receiving portion. The operation panel is provided, for example, on the exterior housing of the liquid ejecting apparatus 100, and outputs input information DY based on input by user operation as an electric signal. The remote control light receiving portion receives, for example, an infrared signal from a remote control, decodes the infrared signal, and outputs the input information DY based on an input from a user’s operation on the remote control as an electric signal. Note that the input device 170 may be provided as needed and may be omitted.

### A2: Electrical Configuration of Liquid Ejecting Apparatus

FIG. 2 is a block diagram illustrating an electrical configuration of the liquid ejecting apparatus 100 according to the first embodiment. As illustrated in FIG. 2, the head module 150 includes a head 151, a drive circuit 152, and a detection circuit 153.

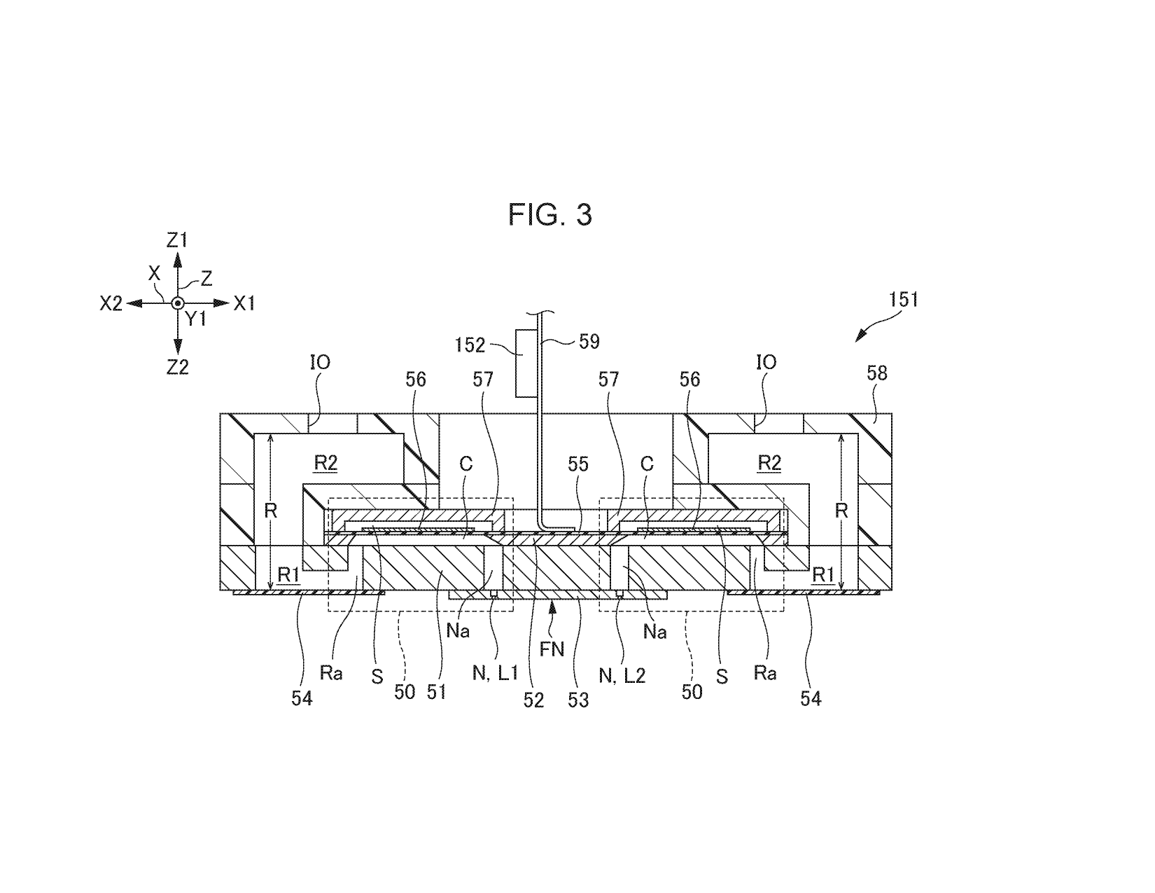

The head 151 includes a plurality of ejection portions 50. Each ejection portion 50 is a structure for ejecting ink, and has a nozzle N, a pressure chamber C, and a piezoelectric element 56, as will be described later with reference to FIG. 3.

The head 151 has M piezoelectric elements 56_1 to 56_M, and the ink is ejected from nozzles N, which will be described later, by driving the piezoelectric elements 56_1 to 56_M. M is a natural number equal to or greater than 2. In the following description, when the piezoelectric elements 56_1 to 56_M are not to be distinguished from one another, the piezoelectric elements 56_1 to 56_M may each be referred to as the piezoelectric element 56. In addition, in the following description, for the M other components in the liquid ejecting apparatus 100 that correspond to the piezoelectric elements 56, the correspondence relationship with the piezoelectric elements 56_1 to 56_M may be indicated using the suffixes “_1 to _M” or “[1] to [M]” in the symbols.

Each piezoelectric element 56 receives a supply drive signal Vin and is driven by an inverse piezoelectric effect. Each piezoelectric element 56 outputs an output signal Vout due to a piezoelectric effect. The details of the head 151 will be described later with reference to FIG. 3.

In the example illustrated in FIG. 2, the head module 150 has one head 151, but the present disclosure is not limited thereto, and the head module 150 may have two or more heads 151.

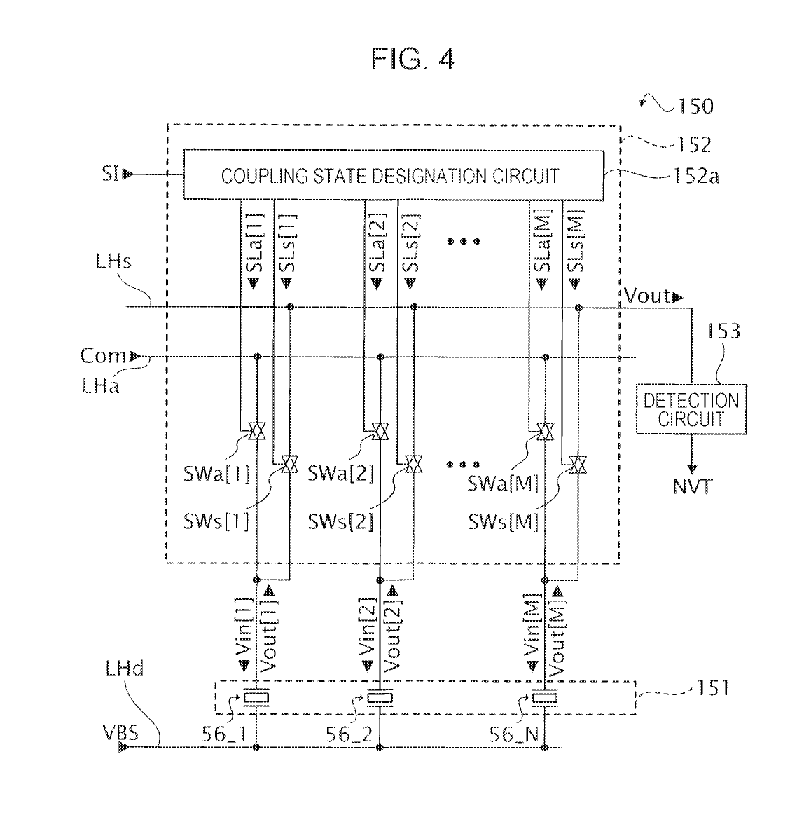

The drive circuit 152 drives the piezoelectric element 56 under the control of the control module 120. Specifically, under the control of the control module 120, the drive circuit 152 switches whether or not to supply the drive signal Com output from the control module 120 as the supply drive signal Vin to each of the plurality of piezoelectric elements 56 included in the head 151. In addition, in the present embodiment, under the control of the control module 120, the drive circuit 152 switches whether or not to supply the electromotive force in the piezoelectric element 56 to the detection circuit 153 as the output signal Vout for each of the plurality of piezoelectric elements 56 of the head 151. The details of the drive circuit 152 will be described later with reference to FIG. 4.

The detection circuit 153 detects residual vibrations that occur in the pressure chamber C when an inspection pulse PD2 (to be described later) is supplied to the piezoelectric element 56. Here, the detection circuit 153 generates vibration information NVT indicating the residual vibration based on the output signal Vout, which is an electric signal generated by each piezoelectric element 56. For example, the detection circuit 153 generates the vibration information NVT by amplifying the output signal Vout after removing the noise therefrom. The residual vibration is a vibration that remains in the pressure chamber C after the piezoelectric element 56 is driven, and vibrates with a natural vibration period (Tc) of the ejection portion 50. As described above, the detection circuit 153 acquires vibration information NVT as an electric signal that indicates the residual vibration of the liquid in the pressure chamber C after the piezoelectric element 56 applies a pressure fluctuation to the liquid in the pressure chamber C.

As illustrated in FIG. 2, the control module 120 includes a control circuit 121, a storage circuit 122, a power supply circuit 123, and a drive signal generation circuit 124.

The control circuit 121 has a function of controlling an operation of each portion of the liquid ejecting apparatus 100 and a function of processing various types of data.

The control circuit 121 includes, for example, one or more processors such as a central processing unit (CPU). The control circuit 121 may include a programmable logic device such as a field-programmable gate array (FPGA) instead of the CPU or in addition to the CPU. In addition, when the control circuit 121 is configured of a plurality of processors, for example, an operation control of the drive circuit 152 and an operation control of the detection circuit 153 may be performed by separate processors. In addition, when the control circuit 121 includes a plurality of processors, the plurality of processors may be mounted on different substrates or the like.

The storage circuit 122 stores various programs executed by the control circuit 121 and various types of data such as print data Img processed by the control circuit 121. The storage circuit 122 includes, for example, a semiconductor memory of one or both of volatile memories such as a random-access memory (RAM) and non-volatile memories such as a read-only memory (ROM), an electrically erasable programmable read-only memory (EEPROM) or a programmable ROM (PROM). The print data Img is supplied from an external device 200 such as a personal computer or a digital camera. A part or the entirety of the storage circuit 122 may be configured as a part of the control circuit 121.

The storage circuit 122 stores vibration information NVT, temperature information DT, input information DY, and viscosity information DV.

The vibration information NVT is information indicating the residual vibration detected by the detection circuit 153 when an inspection pulse PD2 (to be described later) is supplied to the piezoelectric element 56.

The temperature information DT is information indicating the temperature detected by the temperature sensor 160. The temperature indicated by the temperature information DT is a temperature of ink in a pressure chamber C, which will be described later, or a temperature corresponding to that temperature.

The input information DY is information indicating the result of the user’s input to the input device 170 as a reception result from the reception portion 121c (to be described later). The input information DY is information related to the viscosity of the ink in the ejection portion 50, such as information on the viscosity characteristics of the ink, information on the type of ink, and the like.

The viscosity information DV is information indicating the viscosity of the liquid. The viscosity indicated by the viscosity information DV is the viscosity of ink in the pressure chamber C, which will be described later.

The power supply circuit 123 receives electric power from a commercial power source (not illustrated) and generates various predetermined potentials. The various potentials generated are appropriately supplied to each portion of the liquid ejecting apparatus 100. The power supply circuit 123 generates, for example, a power supply potential VHV and an offset potential VBS. The offset potential VBS is supplied to the head module 150. In addition, the power supply potential VHV is supplied to the drive signal generation circuit 124.

The drive signal generation circuit 124 is a circuit that generates the drive signal Com for driving each piezoelectric element 56. Specifically, the drive signal generation circuit 124 includes, for example, a digital-to-analog (DA) conversion circuit and an amplifier circuit. In the drive signal generation circuit 124, the DA conversion circuit converts a waveform designation signal dCom from the control circuit 121 from a digital signal to an analog signal, and the amplifier circuit amplifies the analog signal by using the power supply potential VHV from the power supply circuit 123 to generate the drive signal Com. Here, among the waveforms included in the drive signal Com, the signal having the waveform actually supplied to the piezoelectric element 56 (an ejection pulse PD1 or an inspection pulse PD2 to be described later) is the above-described supply drive signal Vin. The waveform designation signal dCom is a digital signal for defining a waveform of the drive signal Com.

In the above control module 120, the control circuit 121 controls the operation of each portion of the liquid ejecting apparatus 100 by executing the program stored in the storage circuit 122. Here, the control circuit 121 generates control signals Sk1 and Sk2, a control signal SI, and a waveform designation signal dCom as signals for controlling the operation of each portion of the liquid ejecting apparatus 100 by executing the program.

The control signal Sk2 is a signal for controlling driving of the transport mechanism 130. The control signal Sk1 is a signal for controlling the drive of the moving mechanism 140. The control signal SI is a digital signal for designating an operating state of the piezoelectric element 56. The control signal SI may include a timing signal for defining a drive timing of the piezoelectric element 56. The timing signal is generated, for example, based on the output of an encoder that detects the position of the transport body 141 described above.

Furthermore, the control circuit 121 executes a program stored in the storage circuit 122, thereby functioning as an acquisition portion 121a, a control portion 121b, and a reception portion 121c. In this way, the liquid ejecting apparatus 100 includes the acquisition portion 121a, the control portion 121b, and the reception portion 121c.

The acquisition portion 121a acquires viscosity information DV. For example, the acquisition portion 121a acquires the viscosity information DV based on at least one of the vibration information NVT, the temperature information DT, and the input information DY. The acquired viscosity information DV is stored in the storage circuit 122.

More specifically, the higher the viscosity of the ink in the pressure chamber C (to be described later), the higher the attenuation rate of the amplitude of the residual vibration. Therefore, such a relationship between the viscosity of the ink and the attenuation of the amplitude of the residual vibration is acquired in advance, and the acquisition portion 121a acquires the viscosity information DV based on the attenuation state of the amplitude of the residual vibration indicated by the vibration information NVT and this relationship. In this way, the acquisition portion 121a acquires the viscosity information DV based on the electric signal from the detection circuit 153, that is, the vibration information NVT. Accordingly, it is possible to acquire the viscosity information DV without adding an element such as the temperature sensor 160. Alternatively, even when ink with unknown characteristics is used, the viscosity information DV can be acquired.

Furthermore, the higher the temperature of the ink in the pressure chamber C (to be described later), the lower the viscosity of the ink. Therefore, such a relationship between the viscosity and temperature of the ink is acquired in advance, and the acquisition portion 121a acquires the viscosity information DV based on the temperature indicated by the temperature information DT and this relationship. In this way, the acquisition portion 121a acquires the viscosity information DV based on the temperature detected by the temperature sensor 160. Accordingly, viscosity information DV indicating the change in viscosity due to a change in temperature of the liquid can be directly acquired. Here, the above-described relationship between the viscosity of the ink and the attenuation rate of the amplitude of the residual vibration changes depending on the temperature of the ink. Therefore, when acquiring the viscosity information DV based on vibration information NVT, the acquisition portion 121a can also acquire a correlation between the viscosity information DV and the temperature information DT based on the viscosity information DV and the temperature information DT. While the same ink is continuously used, the viscosity information DV can be acquired from the detected temperature information DT by referring to the acquired correlation between the viscosity information DV and the temperature information DT.

Further, the viscosity of ink varies depending on the type of ink. Therefore, the acquisition portion 121a acquires the viscosity information DV based on the reception result from the reception portion 121c, that is, the input information DY. This makes it possible to acquire the viscosity information DV according to the input information DY regarding the type of ink to be used, which is input by the user. Here, the input information DY may be the viscosity information DV, and the acquisition portion 121a may directly acquire the viscosity information DV based on the input information DY. The acquisition portion 121a may also acquire or correct the relationship between the viscosity of the ink and the natural vibration period of the residual vibration based on the input information DY, and then acquire the viscosity information DV based on the vibration information NVT. Furthermore, the acquisition portion 121a may acquire or correct the relationship between the viscosity of ink and the temperature based on the information indicated by the input information DY, and then acquire the viscosity information DV based on the temperature information DT.

The control portion 121b controls the operation of the drive signal generation circuit 124. Here, the control portion 121b corrects the ejection pulse PD1, which will be described later, based on the viscosity information DV.

The reception portion 121c receives an input from the user. In the present embodiment, the reception portion 121c receives an input of the input information DY indicating the result of the input to the input device 170 by a user’s operation.

### A3: Head

FIG. 3 is a cross-sectional view of the head 151. As illustrated in FIG. 3, the head 151 has a plurality of nozzles N that eject ink. The plurality of nozzles N are divided into a first row L1 and a second row L2 which are arranged at intervals in a direction along the X-axis. Each of the first row L1 and the second row L2 is a set of a plurality of nozzles N linearly arranged in the direction along the Y-axis.

The heads 151 have configurations that are substantially symmetrical with respect to each other in the direction along the X-axis. However, positions of the plurality of nozzles N in the first row L1 and the plurality of nozzles N in the second row L2 in the direction along the Y-axis may match or differ from each other. FIG. 3 illustrates a configuration in which the positions of the plurality of nozzles N in the first row L1 and the plurality of nozzles N in the second row L2 in the direction along the Y-axis match with each other.

As illustrated in FIG. 3, the head 151 has a flow path substrate 51, a pressure chamber substrate 52, a nozzle plate 53, a vibration absorbing body 54, a vibration plate 55, a plurality of piezoelectric elements 56, a protective substrate 57, a case 58, and a wiring substrate 59.

The flow path substrate 51 and the pressure chamber substrate 52 are stacked in this order in the Z1 direction, and form a flow path for supplying ink to the plurality of nozzles N. The vibration plate 55, the plurality of piezoelectric elements 56, the protective substrate 57, the case 58, the wiring substrate 59, and the drive circuit 152 are installed in a region that is located in the Z1 direction with respect to a stacked body of the flow path substrate 51 and the pressure chamber substrate 52. On the other hand, the nozzle plate 53 and the vibration absorbing body 54 are installed in a region that is located in the Z2 direction with respect to the stacked body. Each element of the head 151 is schematically a plate-shaped member elongated in the Y direction, and is joined to each other by, for example, an adhesive. Hereinafter, each element of the head 151 will be described in order.

The nozzle plate 53 is a plate-shaped member provided with a plurality of nozzles N in each of the first row L1 and the second row L2. Each of the plurality of nozzles N is a through hole through which the ink passes, and ejects the ink. Here, the surface of the nozzle plate 53 facing the Z2 direction is a nozzle surface FN. For example, the nozzle plate 53 is manufactured by processing a silicon single crystal substrate by a semiconductor manufacturing technology using a processing technique such as dry etching or wet etching. However, other known methods and materials may be appropriately used for manufacturing the nozzle plate 53. Further, the cross-sectional shape of the nozzle is typically a circular shape, but the shape is not limited thereto, and may be a non-circular shape such as a polygon or an ellipse.

The flow path substrate 51 is provided with a space R1, a plurality of supply flow paths Ra, and a plurality of communication flow paths Na for each of the first row L1 and the second row L2. The space R1 is an elongated opening extending in the direction along the Y-axis in a plan view in the direction along the Z-axis. Each of the supply flow path Ra and the communication flow path Na is a through hole formed for each nozzle N. Each supply flow path Ra communicates with the space R1.

The pressure chamber substrate 52 is a plate-shaped member provided with a plurality of pressure chambers C referred to as cavities for each of the first row L1 and the second row L2. The plurality of pressure chambers C are arranged in the direction along the Y-axis. Each pressure chamber C is an elongated space formed for each nozzle N and extending in the direction along the X-axis in a plan view.

Each of the flow path substrate 51 and the pressure chamber substrate 52 is manufactured by processing a silicon single crystal substrate by, for example, a semiconductor manufacturing technology in the same manner as the nozzle plate 53 described above. Note that other known methods and materials may be appropriately used for manufacturing each of the flow path substrate 51 and the pressure chamber substrate 52.

The pressure chamber C is located between the flow path substrate 51 and the vibration plate 55. For each of the first row L1 and the second row L2, the plurality of pressure chambers C are arranged in a direction along the Y-axis. Further, the pressure chamber C communicates with each of the communication flow path Na and the supply flow path Ra. Therefore, the pressure chamber C communicates with the nozzle N through the communication flow path Na and communicates with the space R1 through the supply flow path Ra.

The vibration plate 55 is disposed on a surface of the pressure chamber substrate 52 facing the Z1 direction. The vibration plate 55 is a plate-shaped member that can elastically vibrate. For example, the vibration plate 55 has an elastic film made of silicon oxide (SiO₂) and an insulating film made of zirconium oxide (ZrO₂), and these films are stacked in this order in the Z1 direction. The elastic film is formed, for example, by thermally oxidizing one surface of a silicon single crystal substrate. The insulating film is formed by, for example, forming a zirconium layer by a sputtering method and thermally oxidizing the layer. The vibration plate 55 is not limited to the above-described configuration in which an elastic film and an insulating film are stacked, and may be configured of, for example, a single layer or three or more layers.

On the surface of the vibration plate 55 facing the Z1 direction, a plurality of piezoelectric elements 56 corresponding to the nozzles N are disposed in each of the first row L1 and the second row L2. Each piezoelectric element 56 is driven in response to the supplied drive signal Com to cause a pressure fluctuation in the ink in the pressure chamber C. Each of the piezoelectric elements 56 has an elongated shape extending in the direction along the X-axis in a plan view. The plurality of piezoelectric elements 56 are arranged in a direction along the Y-axis to correspond to the plurality of pressure chambers C. The piezoelectric element 56 overlaps the pressure chamber C in a plan view.

While illustration is not provided, each piezoelectric element 56 includes a first electrode, a piezoelectric layer, and a second electrode, and these are stacked in this order in the Z1 direction. One of the first electrode and the second electrode is an individual electrode disposed to be separated from another electrode of the same type for each piezoelectric element 56, and a drive signal Com is supplied to the one electrode. The other electrode of the first electrode and the second electrode is a band-shaped common electrode extending in the direction along the Y-axis to be continuous over the plurality of piezoelectric elements 56, and a constant offset potential VBS, for example, is supplied to the other electrode. Examples of the metal material of the electrodes include metal materials such as platinum (Pt), aluminum (Al), nickel (Ni), gold (Au), and copper (Cu), and of the materials, one type can be used alone or two or more types can be used in combination in an alloyed or stacked manner. The piezoelectric layer is made of a piezoelectric material such as lead zirconate titanate (Pb(Zr, Ti)O₃) and, for example, has a band shape extending continuously over the plurality of piezoelectric elements 56 in the direction along the Y-axis. Here, the piezoelectric layer is provided with a through hole penetrating the piezoelectric layer extending in the direction along the X-axis in a region corresponding to the gap between the pressure chambers C adjacent to each other in a plan view. When the vibration plate 55 vibrates in conjunction with the above deformation of the piezoelectric element 56, the pressure in the pressure chamber C fluctuates and ink is ejected from the nozzle N as a result. The piezoelectric layer may be individually provided for each piezoelectric element 56.

The protective substrate 57 is a plate-shaped member installed on the surface of the vibration plate 55 facing the Z1 direction, protects the plurality of piezoelectric elements 56, and reinforces a mechanical strength of the vibration plate 55. Here, the plurality of piezoelectric elements 56 are accommodated in a space S between the protective substrate 57 and the vibration plate 55. The protective substrate 57 is made of, for example, a resin material.

The case 58 is a case for storing the ink to be supplied to the plurality of pressure chambers C. The case 58 is made of, for example, a resin material. The case 58 is provided with a space R2 for each of the first row L1 and the second row L2. The space R2 is a space communicating with the above-mentioned space R1 and functions as a reservoir R for storing ink supplied to a plurality of pressure chambers C together with the space R1. The case 58 is provided with an introduction port IO for ink supply to each reservoir R. The ink in each reservoir R is supplied to the pressure chamber C through each supply flow path Ra.

The vibration absorbing body 54 is also called a compliance substrate, is a flexible resin film forming a wall surface of the reservoir R, and absorbs the pressure fluctuation in the ink in the reservoir R. The vibration absorbing body 54 may be a flexible thin plate made of metal. A surface of the vibration absorbing body 54 facing the Z1 direction is joined to the flow path substrate 51 by using an adhesive or the like.

The wiring substrate 59 is mounted on the surface of the vibration plate 55 facing the Z1 direction, and is a mounting component for electrically coupling the control module 120 and the head 151. The wiring substrate 59 is, for example, a flexible wiring substrate such as a chip on film (COF), a flexible printed circuit (FPC), or a flexible flat cable (FFC). The drive circuit 152 described above is mounted on the wiring substrate 59 of the present embodiment. The wiring substrate 59 may be a rigid substrate. In this case, the drive circuit 152 is mounted on the rigid substrate or on a flexible substrate coupled to the rigid substrate.

### A4: Details of Drive Circuit

FIG. 4 is a diagram illustrating a configuration example of the drive circuit 152. As illustrated in FIG. 4, pieces of wiring LHd, LHa, and LHs are coupled to the drive circuit 152. The wiring LHd is a power supply line to which the offset potential VBS is supplied. The wiring LHa is a signal line that transmits the drive signal Com. The wiring LHs is a signal line that transmits the output signal Vout.

The drive circuit 152 has M switches SWa (SWa[1] to SWa[M]), M switches SWs (SWs[1] to SWs[M]), and a coupling state designation circuit 152a that designates the coupling state of these switches.

The switch SWa[m] is a switch that switches between conduction (ON) and non-conduction (OFF) between the wiring LHa for transmitting the drive signal Com and the piezoelectric element 56[m]. Here, m is a natural number of 1 or more and M or less. The switch SWs[m] is a switch that switches between conduction (ON) and non-conduction (OFF) between the wiring LHs for transmitting the output signal Vout and the piezoelectric element 56[m]. Each of these switches is, for example, a transmission gate.

Based on the control signal SI, the coupling state designation circuit 152a generates coupling state designation signals SLa[1] to SLa[M] that designate the on and off of the switches SWa[1] to SWa[M], and coupling state designation signals SLs[1] to SLs[M] that designate the on and off of the switches SWs[1] to SWs[M].

The switch SWa[m] is switched on and off in accordance with the coupling state designation signal SLa[m] generated as described above. For example, the switch SWa[m] is in an on state when the coupling state designation signal SLa[m] is at a high level and is in an off state when the coupling state designation signal SLa[m] is at a low level. As described above, the drive circuit 152 supplies a portion or all of the waveform included in the drive signal Com as the supply drive signal Vin to one or more piezoelectric elements 56 selected from the piezoelectric elements 56_1 to 56_M.

Furthermore, the switch SWs[m] is switched on and off in accordance with the coupling state designation signal SLs[m]. For example, the switch SWs[m] is in an on state when the coupling state designation signal SLs[m] is at a high level and is in an off state when the coupling state designation signal SLs[m] is at a low level. As described above, the drive circuit 152 supplies, to the detection circuit 153, the output signal Vout from one or more piezoelectric elements 56 selected from the piezoelectric elements 56_1 to 56_M.

### A5: Drive Signal

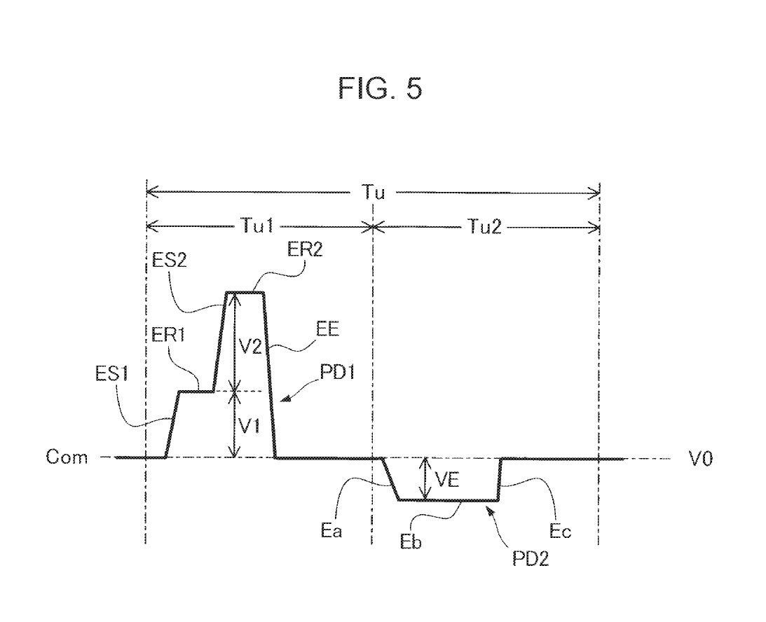

FIG. 5 is an explanatory diagram of the ejection pulse PD1 and the inspection pulse PD2 included in the drive signal Com. As illustrated in FIG. 5, the drive signal Com includes the ejection pulse PD1 and the inspection pulse PD2, and is repeated with a unit period Tu. The unit period Tu is divided into a preceding period Tu1 including the ejection pulse PD1 and a succeeding period Tu2 including the inspection pulse PD2. In the example illustrated in FIG. 5, the length of the period Tu1 and the length of the period Tu2 are equal to each other. In the present embodiment, the period Tu1 and the period Tu2 are used as control periods for switching the switch SWa[m] and the switch SWs[m], respectively.

The switching of the switch SWa[m] and the switch SWs[m] may be performed in a control period shorter than the period Tu1 or the period Tu2. Further, the length of the period Tu1 and the length of the period Tu2 may be different from each other. Although not illustrated, the switches SWa[2] to SWa[M] and the switches SWs[2] to SWs[M] are also switched over during the period Tu1 and the period Tu2, respectively, as control periods.

The ejection pulse PD1 is a pulse for ejecting ink from the nozzle N as a droplet. The ejection pulse PD1 is supplied to the piezoelectric element 56, thereby causing a pressure fluctuation in the ink in the pressure chamber C such that the ink is ejected from the nozzle N. In the example illustrated in FIG. 5, the ejection pulse PD1 has, in this order, a first contraction element ES1, a first contraction maintaining element ER1, a second contraction element ES2, a second contraction maintaining element ER2, and an expansion element EE.

The first contraction element ES1 changes in potential by a first potential change amount V1 to contract the pressure chamber C. The first contraction maintaining element ER1 is coupled to the terminal end of the first contraction element ES1 and maintains the terminal potential of the first contraction element ES1. The second contraction element ES2 is coupled to the terminal end of the first contraction maintaining element ER1, and changes in potential by a second potential change amount V2 to contract the pressure chamber C. The second contraction maintaining element ER2 is coupled to the terminal end of the second contraction element ES2 and maintains the terminal potential of the second contraction element ES2. The expansion element EE changes in potential to expand the pressure chamber C.

Here, the starting potential of the first contraction element ES1 and the terminal potential of the expansion element EE are both a reference potential V0.

The inspection pulse PD2 is a pulse for detecting residual vibration. The inspection pulse PD2 is supplied to the piezoelectric element 56, thereby causing a pressure fluctuation in the ink in the pressure chamber C without causing ink to be ejected from the nozzle N. In the example illustrated in FIG. 5, the inspection pulse PD2 has an expansion element Ea, an expansion maintaining element Eb, and a contraction element Ec in this order.

The expansion element Ea changes in potential by a potential change amount VE to expand the pressure chamber C. The expansion maintaining element Eb is coupled to the terminal end of the expansion element Ea and maintains the terminal potential of the expansion element Ea. The contraction element Ec changes in potential by a potential change amount VE to contract the pressure chamber C. In this manner, the potential of the inspection pulse PD2 drops to a potential lower than the reference potential V0, and after maintaining that potential for a predetermined time, returns to the reference potential V0. A waveform of the inspection pulse PD2 is not limited to the example illustrated in FIG. 5 and may be any waveform as long as it can cause a pressure fluctuation in the ink in the pressure chamber C without causing ink to be ejected from the nozzle N.

### A6: Method for Driving Liquid Ejecting Apparatus

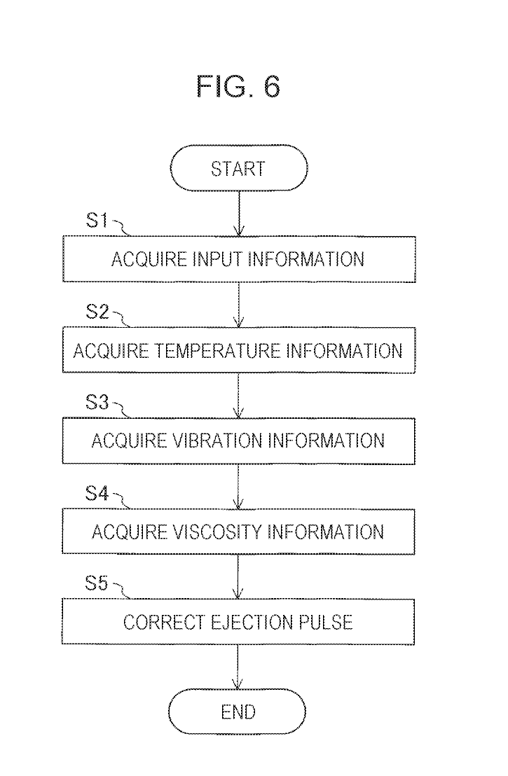

FIG. 6 is a flowchart illustrating a method for driving the liquid ejecting apparatus 100 according to the first embodiment. As illustrated in FIG. 6, the driving method includes steps S1 to S5 in this order. The order of steps S1 to S3 is not limited to the example illustrated in FIG. 6, and may be optional as long as they are performed before step S4.

In step S1, the control circuit 121 functioning as the reception portion 121c receives input information DY. More specifically, in step S1, the reception portion 121c receives the result of the user’s input to the input device 170 as input information DY. The received input information DY is stored in the storage circuit 122.

After step S1, in step S2, the control circuit 121 acquires temperature information DT. More specifically, in step S2, the control circuit 121 acquires the detection result of the temperature sensor 160 as the temperature information DT. The acquired temperature information DT is stored in the storage circuit 122. As described above, step S2 may be performed before step S4, or may be performed before step S1.

After step S2, in step S3, the control circuit 121 acquires vibration information NVT. More specifically, in step S3, the control circuit 121 acquires the vibration information NVT from the detection circuit 153, which indicates the residual vibration of the ink in the pressure chamber C after a pressure fluctuation is applied to the ink in the pressure chamber C by supplying the inspection pulse PD2 to the piezoelectric element 56. The acquired vibration information NVT is stored in the storage circuit 122. As described above, step S3 may be performed before step S4, or may be performed before step S1 or step S2.

After steps S1 to S3, in step S4, the control circuit 121 functioning as the acquisition portion 121a acquires viscosity information DV based on the input information DY, the temperature information DT, and the vibration information NVT. The acquired viscosity information DV is stored in the storage circuit 122.

After step S4, in step S5, the control circuit 121 functioning as the control portion 121b corrects the ejection pulse PD1 based on the viscosity information DV. This correction will be described in detail below.

### A7: Correction of Ejection Pulse

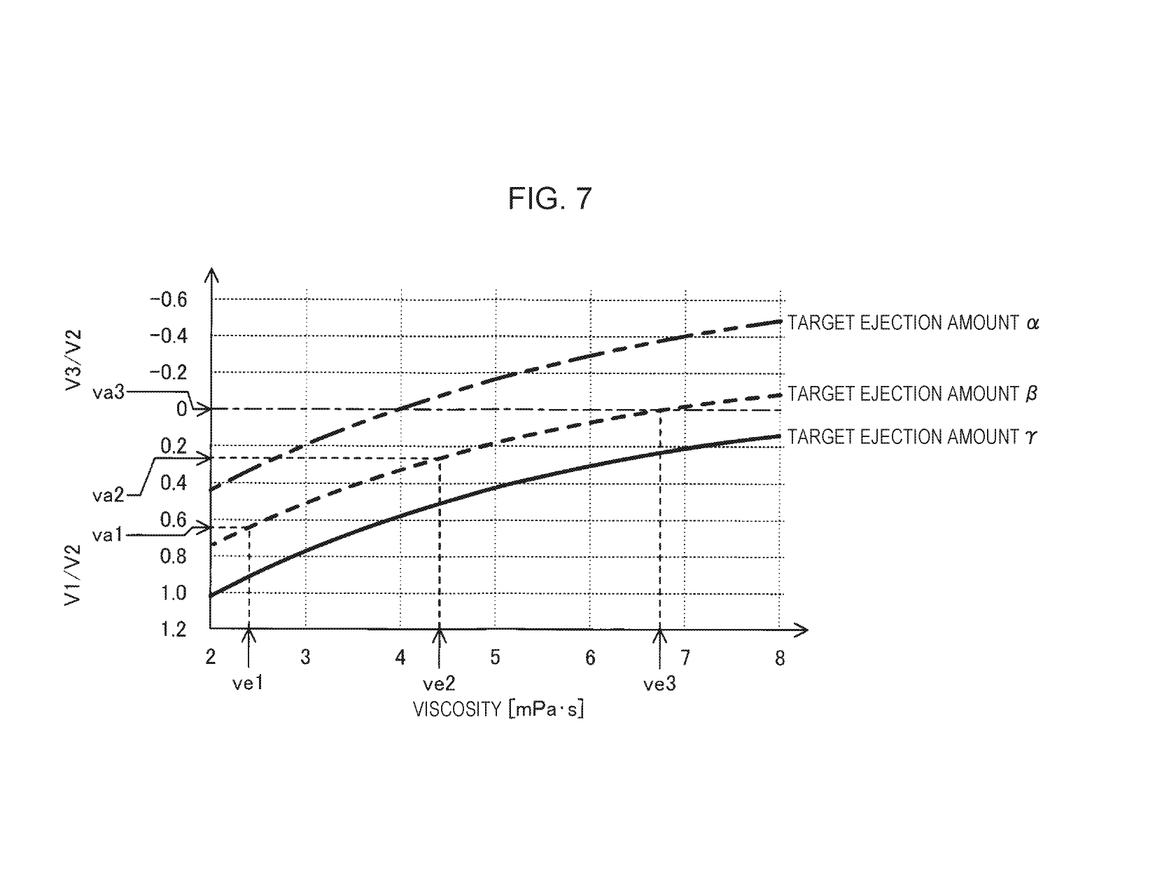

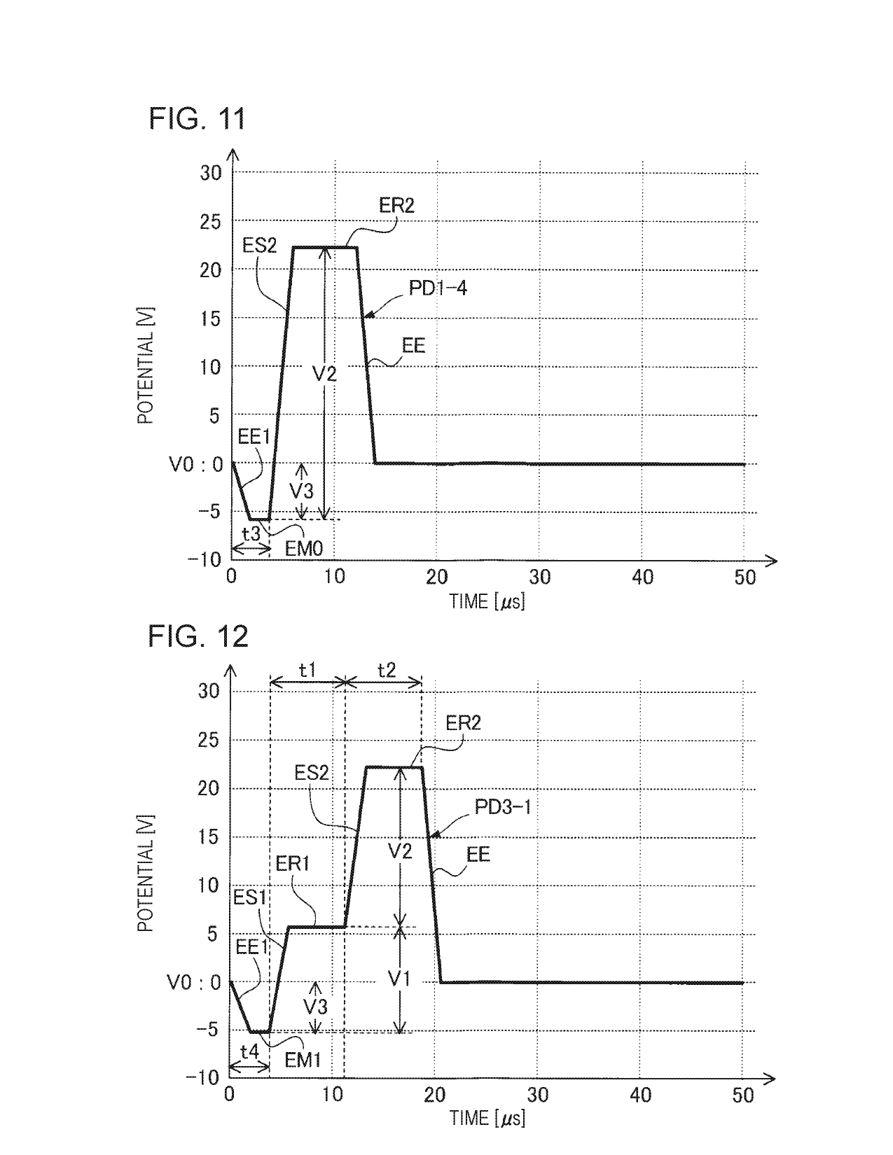

FIG. 7 is a diagram illustrating the relationship between the viscosity of the liquid and the ratio of the potential change amounts of the ejection pulse PD. FIG. 7 illustrates the relationship between the viscosity of the ink and the ratio (V1/V2) of the first potential change amount V1 to the second potential change amount V2 when the actual ejection amount is a target ejection amount α, β, or γ, and the relationship between the viscosity of the ink and the ratio (V3/V2) of a third potential change amount V3 to the second potential change amount V2. Here, the sum of the first potential change amount V1 and the second potential change amount V2 is constant. The third potential change amount V3 is a potential change amount of a first expansion element EE1 illustrated in FIG. 11 and described later.

In FIG. 7, the vertical axis represents the ratio of the potential change amounts of the ejection pulse PD, and the horizontal axis represents the viscosity of the ink. The ratio (V3/V2) of the third potential change amount V3 to the second potential change amount V2 is shown as a negative value, and the ratio (V1/V2) of the first potential change amount V1 to the second potential change amount V2 is shown as a positive value.

As illustrated in FIG. 7, when the ejection amount is constant, the higher the viscosity of the ink, the smaller the absolute value of the ratio (V1/V2). Further, when the ejection amount is constant, the higher the viscosity of the ink, the larger the absolute value of the ratio (V3/V2).

In the related art, in an ejection pulse PD1-4 having a first expansion element EE1, an expansion maintaining element EM0, a second contraction element ES2, a second contraction maintaining element ER2, and an expansion element EE in this order as illustrated in FIG. 11, by correcting the ratio (V3/V2) of the third potential change amount V3 to the second potential change amount V2, it is possible to keep the ejection amount constant. In the case of such an ejection pulse PD1-4, at the target ejection amount α, it is possible to keep the ejection amount constant by correcting the ratio (V3/V2) under the condition that the viscosity is 4 mPa·s or more, and at the target ejection amount β, which is smaller than the target ejection amount α, it is possible to keep the ejection amount constant by correcting the ratio (V3/V2) under the condition that the viscosity is 6.7 mPa·s or more. However, the target ejection amount β cannot be achieved by correcting the ratio (V3/V2).

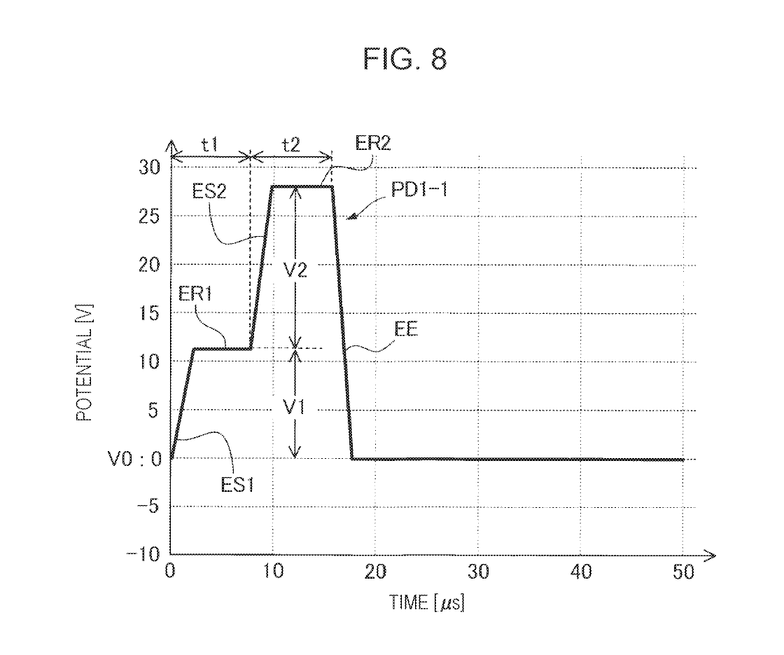

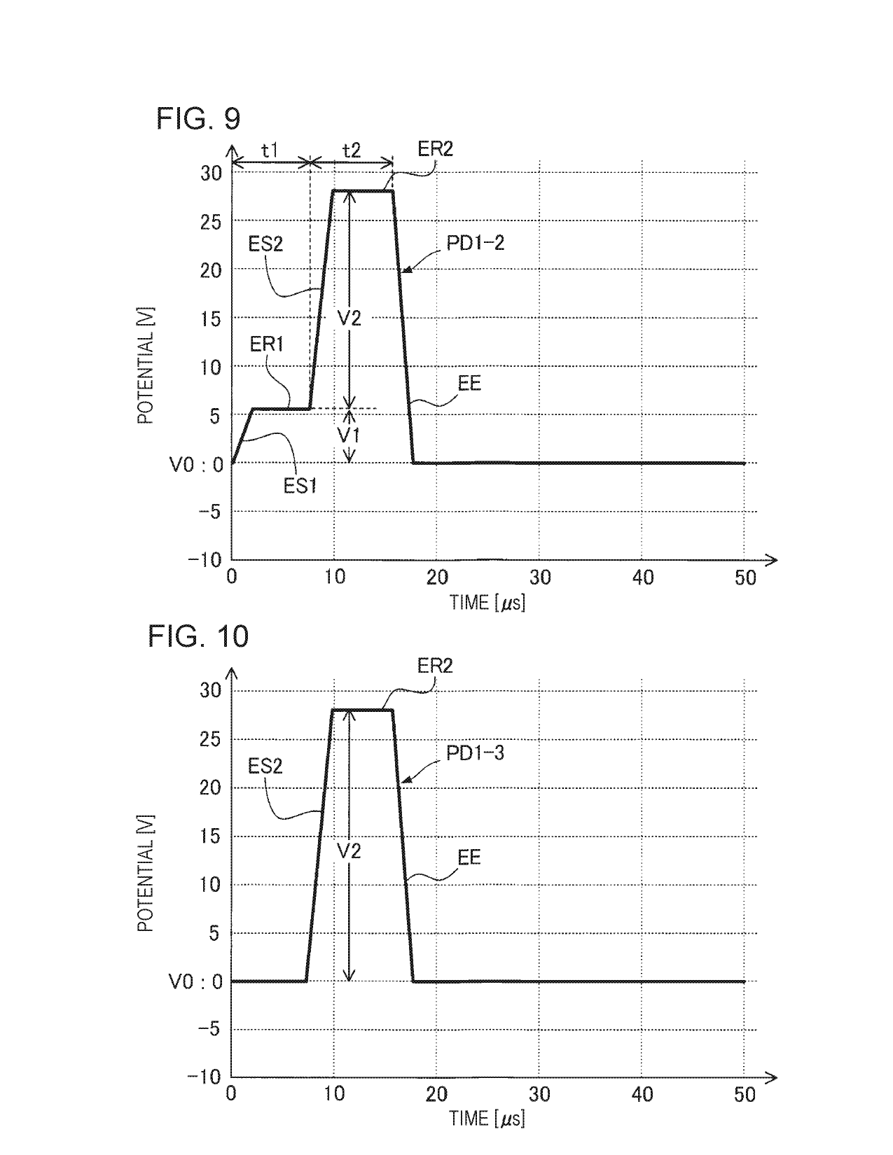

On the other hand, in ejection pulses PD1-1 and PD1-2 having a first contraction element ES1, a first contraction maintaining element ER1, a second contraction element ES2, a second contraction maintaining element ER2, and an expansion element EE illustrated in FIGS. 8 and 9, by correcting the ratio (V1/V2) of the first potential change amount V1 to the second potential change amount V2, it is possible to keep the ejection amount constant even at the target ejection amount γ. Furthermore, by correcting the ratio (V1/V2), it is possible to keep the ejection amount constant even for the target ejection amounts β and γ up to a range where the ink viscosity is lower.

Therefore, as described above, in the ejection pulse PD1 having the first contraction element ES1, the first contraction maintaining element ER1, the second contraction element ES2, the second contraction maintaining element ER2, and the expansion element EE, by correcting the ratio (V1/V2) in accordance with the viscosity of the ink, it is possible to keep an ejection amount constant over a wide range of viscosity.

When the viscosity indicated by the viscosity information DV is a first viscosity ve1, the ratio (V1/V2) corresponding to the target ejection amount β is a first value va1. When the viscosity indicated by the viscosity information DV is a second viscosity ve2 that is higher than the first viscosity ve1, the ratio (V1/V2) corresponding to the target ejection amount β is a second value va2 that is smaller than the first value va1. When the viscosity indicated by the viscosity information DV is a third viscosity ve3 that is higher than the second viscosity ve2, the ratio (V1/V2) corresponding to the target ejection amount β is a third value va3 that is smaller than the second value va2.

FIG. 7 illustrates the first viscosity ve1, the second viscosity ve2, the third viscosity ve3, the first value va1, the second value va2, and the third value va3 in the case of the target ejection amount β. In the example illustrated in FIG. 7, the first viscosity ve1 is substantially 2.3 mPa·s, the second viscosity ve2 is substantially 4.4 mPa·s, the third viscosity ve3 is substantially 6.7 mPa·s, the first value va1 is substantially 0.67, the second value va2 is substantially 0.25, and the third value va3 is substantially 0.

In this manner, by decreasing the ratio (V1/V2) of the first potential change amount V1 to the second potential change amount V2 as the viscosity indicated by the viscosity information DV increases, it is possible to reduce a fluctuation in the ejection amount caused by an increase in the viscosity of the liquid over a wider range of viscosity changes in the liquid and suppress unstable ejection. In other words, by increasing the ratio (V1/V2) of the first potential change amount V1 to the second potential change amount V2 as the viscosity indicated by the viscosity information DV decreases, it is possible to reduce a fluctuation in the ejection amount caused by an increase in the viscosity of the liquid over a wider range of viscosity changes in the liquid and suppress unstable ejection. An example of correcting the ejection pulse PD1 will be described below with reference to FIGS. 8 to 11. Note that, in the following, an aspect will be illustrated in which the ratio (V1/V2) and the ratio (V3/V2) are mainly adjusted, but the present disclosure is not limited to this aspect, and in addition to adjusting the ratio (V1/V2) and the ratio (V3/V2), adjustment of other parameters may also be performed in consideration of the ejection amount, the ejection speed, and the like.

FIG. 8 is an explanatory diagram of an ejection pulse PD1-1, which is the ejection pulse PD1 when the viscosity indicated by the viscosity information DV is the first viscosity ve1. As described above with reference to FIG. 5, the ejection pulse PD1-1 has a first contraction element ES1, a first contraction maintaining element ER1, a second contraction element ES2, a second contraction maintaining element ER2, and an expansion element EE.

Here, by making the sum of a period of the first contraction element ES1 and a period of the first contraction maintaining element ER1, that is, a period t1 from the start of the first contraction element ES1 to the start of the second contraction element ES2, substantially equal to 1/2 of the natural vibration period (Tc) of the ejection portion 50, the vibration caused by the first contraction element ES1 can weaken the second contraction element ES2.

From this viewpoint, the period t1 from the start of the first contraction element ES1 to the start of the second contraction element ES2 is preferably from 0.3 times to 0.7 times the natural vibration period (Tc) of the ejection portion 50, and more preferably from 0.4 times to 0.6 times the natural vibration period (Tc) of the ejection portion 50. Accordingly, the vibration caused by the first contraction element ES1 can suitably weaken the vibration caused by the second contraction element ES2. As a result, the correction width of the ejection amount based on the ratio of the first potential change amount V1 to the second potential change amount V2 can be increased.

Furthermore, by making the sum of a period of the second contraction element ES2 and a period of the second contraction maintaining element ER2, that is, a period t2 from the start end of the second contraction element ES2 to the terminal end of the second contraction maintaining element ER2, substantially equal to the natural vibration period (Tc) of the ejection portion 50, it is possible to exert the effect of damping the residual vibration of the ink in the pressure chamber C after the ink is ejected by the second contraction element ES2.

From this viewpoint, the period t2 from the start end of the second contraction element ES2 to the terminal end of the second contraction maintaining element ER2 is preferably from 0.8 times to 1.2 times the natural vibration period (Tc) of the ejection portion 50, and more preferably from 0.9 times to 1.1 times the natural vibration period (Tc) of the ejection portion 50. Accordingly, it is possible to reduce the ink ejection time interval and suppress deterioration in the ejection characteristics of subsequent ink by suppressing the residual vibration of the ink in the pressure chamber C after the ink is ejected by the second contraction element ES2.

FIG. 9 is an explanatory diagram of an ejection pulse PD1-2, which is the ejection pulse PD1 when the viscosity indicated by the viscosity information DV is the second viscosity ve2. The ejection pulse PD1-2 has a first contraction element ES1, a first contraction maintaining element ER1, a second contraction element ES2, a second contraction maintaining element ER2, and an expansion element EE, similarly to the above-described ejection pulse PD1-1.

However, the ratio (V1/V2) in the ejection pulse PD1-2 is smaller than the ratio (V1/V2) in the above-described ejection pulse PD1-1. Accordingly, the ejection amount when the viscosity indicated by the viscosity information DV is the second viscosity ve2 can be brought close to the ejection amount when the viscosity indicated by the viscosity information DV is the first viscosity ve1.

In the example illustrated in FIG. 9, the first potential change amount V1 in the ejection pulse PD1-2 is smaller than the first potential change amount V1 in the ejection pulse PD1-1. Here, it is preferable that the second potential change amount V2 when the viscosity indicated by the viscosity information DV is the first viscosity ve1 and the second potential change amount V2 when the viscosity indicated by the viscosity information DV is the second viscosity ve2 are equal to each other. Accordingly, it is possible to suitably reduce fluctuations in the ejection amount caused by an increase in the viscosity of the liquid.

In addition, the second potential change amount V2 in the ejection pulse PD1-2 may be larger than the second potential change amount V2 in the ejection pulse PD1-1, to the extent that the first potential change amount V1 in the ejection pulse PD1-2 is smaller than the first potential change amount V1 in the ejection pulse PD1-1. That is, the ratio (V1/V2) may be changed such that the sum of the first potential change amount V1 and the second potential change amount V2 does not change.

FIG. 10 is an explanatory diagram of an ejection pulse PD1-3, which is the ejection pulse PD1 when the viscosity indicated by the viscosity information DV is the third viscosity ve3. The ejection pulse PD1-3 does not have a first contraction element ES1 and a first contraction maintaining element ER1, and has a second contraction element ES2, a second contraction maintaining element ER2, and an expansion element EE. By not having the first contraction element ES1 and the first contraction maintaining element ER1, the vibration caused by the second contraction maintaining element ER2 is not weakened. In addition, the ratio (V1/V2) of the ejection pulse PD1-3, which does not have the first contraction element ES1 and the first contraction maintaining element ER1, is 0, and the ratio (V1/V2) in the ejection pulse PD1-3 is smaller than the ratio (V1/V2) in the above-described ejection pulse PD1-2.

FIG. 11 is an explanatory diagram of an ejection pulse PD1-4, which is another example of the ejection pulse PD1 when the viscosity indicated by the viscosity information DV is higher than the third viscosity ve3. The ejection pulse PD1-4 does not have a first contraction element ES1 and a first contraction maintaining element ER1, similarly to the ejection pulse PD1-3. However, the ejection pulse PD1-4 has a first expansion element EE1 and an expansion maintaining element EM0. That is, the ejection pulse PD1-4 does not have a first contraction element ES1 and a first contraction maintaining element ER1, and has a first expansion element EE1, an expansion maintaining element EM0, a second contraction element ES2, a second contraction maintaining element ER2, and an expansion element EE.

The first expansion element EE1 changes in potential by a third potential change amount V3 to expand the pressure chamber C before the second contraction element ES2 changes in potential. The expansion maintaining element EM0 maintains the terminal potential of the first expansion element EE1 from the terminal end of the first expansion element EE1 to the start end of the second contraction element ES2. By using the first expansion element EE1 and the expansion maintaining element EM0 in this way, it is possible to suppress a shortage of the ejection amount even when the viscosity of the liquid is higher. Therefore, the ejection pulse PD1-4 may be used when the viscosity indicated by the viscosity information DV is a fourth viscosity higher than the third viscosity ve3. In this case, adjustment may be made such that the ratio (V3/V2) of the third potential change amount V3 to the second potential change amount V2 increases as the viscosity indicated by the viscosity information DV increases.

Here, by making the sum of a period of the first expansion element EE1 and a period of the expansion maintaining element EM0, that is, a period t3 from the start of the first expansion element EE1 to the start of the second contraction element ES2, substantially equal to 1/2 of the natural vibration period (Tc) of the ejection portion 50, the timing of vibration inversion and the timing of vibration contraction overlap, which has the advantage of making it easier to ensure the ejection amount and the ejection speed.

From this viewpoint, the period t3 from the start of the first expansion element EE1 to the start of the second contraction element ES2 is preferably from 0.3 times to 0.7 times the natural vibration period (Tc) of the ejection portion 50, and more preferably from 0.4 times to 0.6 times the natural vibration period (Tc) of the ejection portion 50. Accordingly, it is possible to efficiently suppress a shortage in the ejection amount even when the viscosity of the liquid is higher.

As described above, in the present embodiment, by decreasing the ratio (V1/V2) of the first potential change amount V1 to the second potential change amount V2 as the viscosity indicated by the viscosity information DV increases, it is possible to reduce a fluctuation in the ejection amount caused by an increase in the viscosity of the liquid over a wider range of viscosity changes in the liquid and suppress unstable ejection.

### B: Second Embodiment

Hereinafter, a second embodiment of the present disclosure will be described. In the embodiment illustrated below, elements having the same effects and functions as those of the first embodiment will be given the reference numerals used in the description of the first embodiment, and each of the detailed descriptions thereof will be appropriately omitted.

The present embodiment is similar to the first embodiment except that the waveform of the ejection pulse is different.

FIG. 12 is an explanatory diagram of an ejection pulse PD3-1 when the viscosity indicated by the viscosity information DV is the first viscosity ve1 in the second embodiment. The ejection pulse PD3-1 is similar to the ejection pulse PD1-1 of the first embodiment except that a first expansion element EE1 and a first expansion maintaining element EM1 are added. That is, the ejection pulse PD3-1 has, in this order, a first expansion element EE1, a first expansion maintaining element EM1, a first contraction element ES1, a first contraction maintaining element ER1, a second contraction element ES2, a second contraction maintaining element ER2, and an expansion element EE.

The first expansion element EE1 changes in potential by a third potential change amount V3 to expand the pressure chamber C before the first contraction element ES1 changes in potential. The first expansion maintaining element EM1 maintains the terminal potential of the first expansion element EE1 from the terminal end of the first expansion element EE1 to the start end of the first contraction element ES1. By using such first expansion element EE1 and first expansion maintaining element EM1, the meniscus of the liquid in the nozzle N can be stabilized by slightly retracting the meniscus into the nozzle N immediately before ejection, thereby reducing variations in the ejection amount or the ejection speed.

Here, the third potential change amount V3 is not particularly limited, but is, for example, about 0.2 × (V1 + V2).

Furthermore, by adding the first contraction element ES1 at a timing that resonates with the vibration generated by the first expansion element EE1, and then adding the second contraction element ES2 at a timing that does not resonate with the vibration of the first contraction element ES1, that is, at a timing that is 1/2 the natural vibration period (Tc) of the ejection portion 50, the vibration caused by the first contraction element ES1 can be used to suitably weaken the vibration caused by the second contraction element ES2, making it possible to stably eject the desired amount of ink even when the viscosity of the ink is low.

From this viewpoint, a period t4 from the start of the first expansion element EE1 to the start of the first contraction element ES1 is preferably from 0.3 times to 0.7 times the natural vibration period (Tc) of the ejection portion 50, and more preferably from 0.4 times to 0.6 times the natural vibration period (Tc) of the ejection portion 50. Accordingly, the liquid can be efficiently ejected.

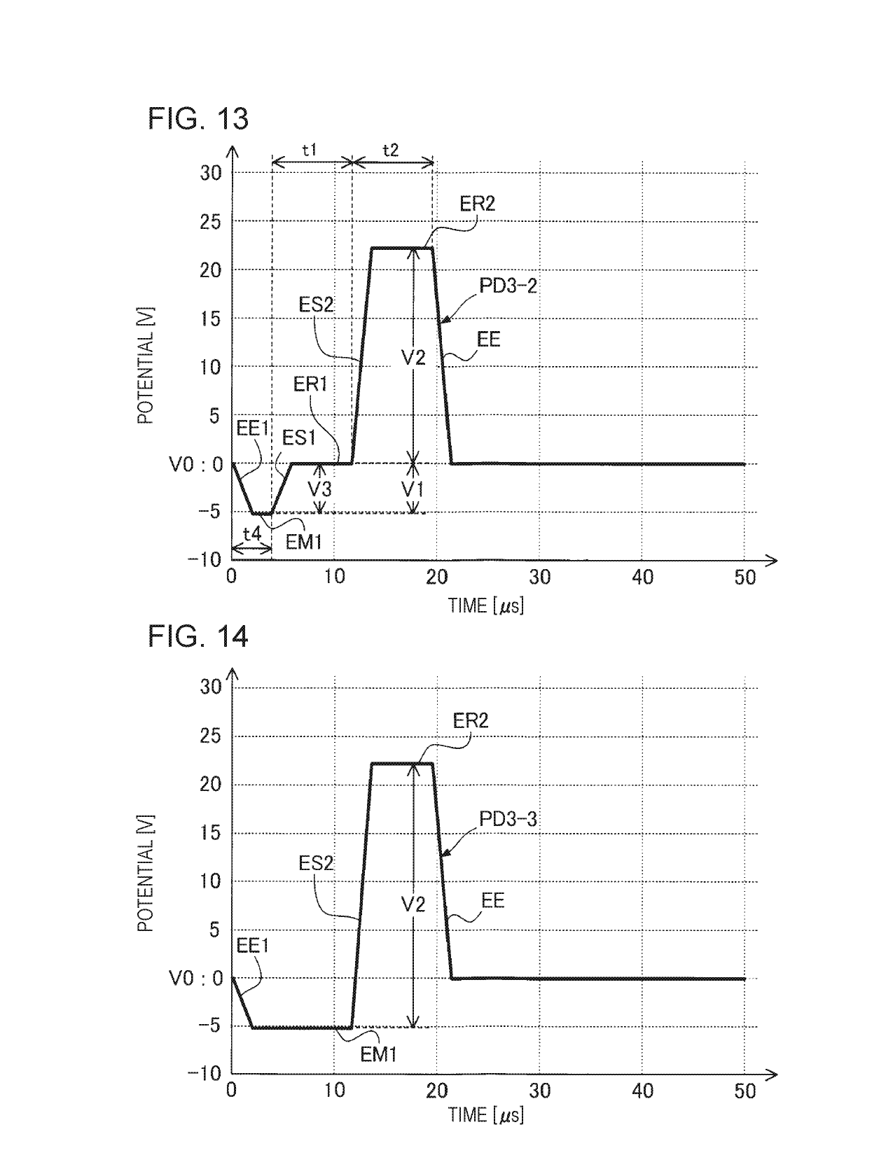

FIG. 13 is an explanatory diagram of an ejection pulse PD3-2 when the viscosity indicated by the viscosity information DV is the second viscosity ve2 in the second embodiment. The ejection pulse PD3-2 has, in this order, a first expansion element EE1, a first expansion maintaining element EM1, a first contraction element ES1, a first contraction maintaining element ER1, a second contraction element ES2, a second contraction maintaining element ER2, and an expansion element EE, similarly to the above-described ejection pulse PD3-1.

However, the ratio (V1/V2) in the ejection pulse PD3-2 is smaller than the ratio (V1/V2) in the above-described ejection pulse PD3-1. Accordingly, the ejection amount when the viscosity indicated by the viscosity information DV is the second viscosity ve2, which is higher than the first viscosity ve1, can be brought close to the ejection amount when the viscosity indicated by the viscosity information DV is the first viscosity ve1.

In the example illustrated in FIG. 13, the first potential change amount V1 in the ejection pulse PD3-2 is smaller than the first potential change amount V1 in the ejection pulse PD3-1. Here, the second potential change amount V2 in the ejection pulse PD3-2 is larger than the second potential change amount V2 in the ejection pulse PD3-1, to the extent that the first potential change amount V1 in the ejection pulse PD3-2 is smaller than the first potential change amount V1 in the ejection pulse PD3-1. That is, the ratio (V1/V2) is changed such that the sum of the first potential change amount V1 and the second potential change amount V2 does not change.

Note that, the second potential change amount V2 when the viscosity indicated by the viscosity information DV is the first viscosity ve1 and the second potential change amount V2 when the viscosity indicated by the viscosity information DV is the second viscosity ve2 may be equal to each other. In this case, it is possible to suitably reduce the fluctuations in the ejection amount caused by the increase in the viscosity of the liquid.

FIG. 14 is an explanatory diagram of an ejection pulse PD3-3 when the viscosity indicated by the viscosity information DV is the third viscosity ve3 in the second embodiment. The ejection pulse PD3-3 does not have a first contraction element ES1 and a first contraction maintaining element ER1, and has a first expansion element EE1, a first expansion maintaining element EM1, a second contraction element ES2, a second contraction maintaining element ER2, and an expansion element EE.

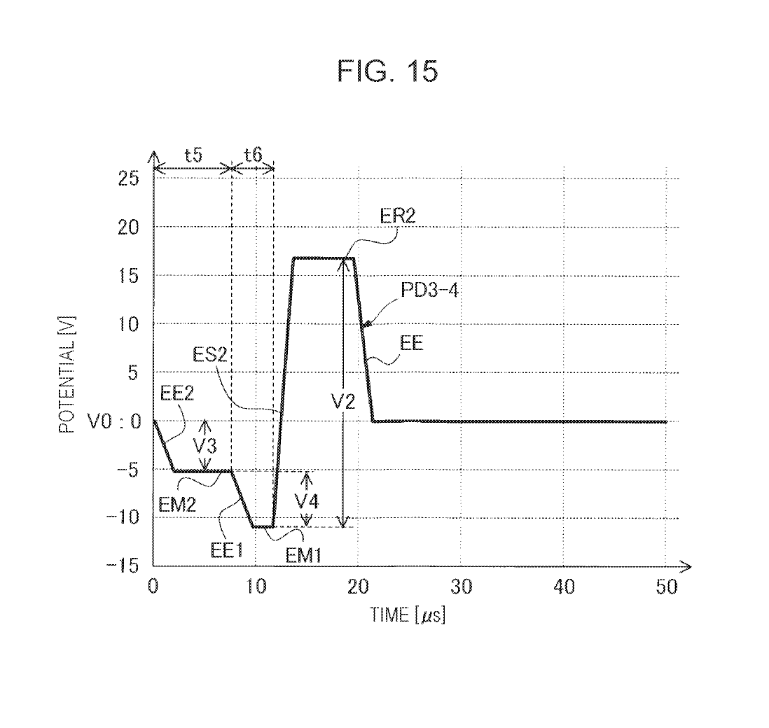

FIG. 15 is an explanatory diagram of another example of an ejection pulse PD3-4 when the viscosity indicated by the viscosity information DV is the third viscosity ve3 in the second embodiment. The ejection pulse PD3-4 does not have a first contraction element ES1 and a first contraction maintaining element ER1, similarly to the ejection pulse PD3-3. However, the ejection pulse PD3-4 has a second expansion element EE2 and a second expansion maintaining element EM2. That is, the ejection pulse PD3-4 does not have a first contraction element ES1 and a first contraction maintaining element ER1, and has a first expansion element EE1, an expansion maintaining element EM0, a second expansion element EE2, a second expansion maintaining element EM2, a second contraction element ES2, a second contraction maintaining element ER2, and an expansion element EE.

The second expansion element EE2 changes in potential by a fourth potential change amount V4 to expand the pressure chamber C before the first expansion element EE1 changes in potential. The second expansion maintaining element EM2 maintains the terminal potential of the second expansion element EE2 from the terminal end of the second expansion element EE2 to the start end of the first expansion element EE1. By using such second expansion element EE2 and second expansion maintaining element EM2, it is possible to suppress a shortage of the ejection amount even when the viscosity of the liquid is higher. Therefore, the ejection pulse PD3-4 may be used when the viscosity indicated by the viscosity information DV is a fourth viscosity higher than the third viscosity ve3. In this case, adjustment may be made such that the ratio (V4/V2) of the fourth potential change amount V4 to the second potential change amount V2 increases as the viscosity indicated by the viscosity information DV increases.

Here, from the viewpoint of efficient ejection, it is preferable that the start timing of the first expansion element EE1 is the timing at which it resonates with the vibration generated in the second expansion element EE2, that is, after a period substantially equal to the natural vibration period (Tc) of the ejection portion 50 from the start end of the second expansion element EE2. That is, a period t5 from the start of the second expansion element EE2 to the start of the first expansion element EE1 is preferably from 0.8 times to 1.2 times the natural vibration period (Tc) of the ejection portion 50, and more preferably from 0.9 times to 1.1 times the natural vibration period (Tc) of the ejection portion 50.

Furthermore, it is preferable that the start timing of the second contraction element ES2 be the timing at which it resonates with the vibration caused by the first expansion element EE1, that is, a period substantially equal to 1/2 the natural vibration period (Tc) of the ejection portion 50 from the start end of the first expansion element EE1. That is, a period t6 from the start of the first expansion element EE1 to the start of the second contraction element ES2 is preferably from 0.3 times to 0.7 times the natural vibration period (Tc) of the ejection portion 50, and more preferably from 0.4 times to 0.6 times the natural vibration period (Tc) of the ejection portion 50.

According to the second embodiment described above, it is also possible to reduce a fluctuation in the ejection amount caused by increases in the viscosity of the liquid and to suppress unstable ejection over a wider range of viscosity changes of the liquid.

### C: Modification Example

Each embodiment in the above illustration can be variously modified. Specific modification aspects that can be applied to each of the above-described forms will be described below. The aspects selected in any manner from the following examples can be appropriately combined with each other within a range of not being inconsistent with each other.

### C1: Modification Example 1

In the above-described embodiment, an aspect has been illustrated in which viscosity information DV is acquired based on the vibration information NVT, the temperature information DT, and the input information DY, but the present disclosure is not limited to this aspect, and for example, viscosity information DV may be acquired based on at least one of the vibration information NVT, the temperature information DT, and the input information DY.

### C2: Modification Example 2

In the above-described embodiment, an aspect has been illustrated in which the residual vibration is detected using the inspection pulse PD2, but the present disclosure is not limited to this aspect, and the residual vibration may be detected using the ejection pulse PD1 as the inspection pulse. That is, the ejection pulse PD1 may also serve as the “inspection pulse”.

### C3: Modification Example 3

In the above-described embodiment, an aspect has been illustrated in which the ejection pulse PD1 and the inspection pulse PD2 are transmitted through a single signal line, but the present disclosure is not limited to this aspect, and the ejection pulse PD1 and the inspection pulse PD2 may be transmitted through separate transmission lines. In addition, the drive signal Com may include signals or pulses other than the ejection pulse PD1 and the inspection pulse PD2.

### C4: Modification Example 4

In each of the above-described embodiments, a serial type liquid ejecting apparatus 100 in which the transport body 141 having the head 151 mounted thereon is reciprocated has been illustrated, but the present disclosure can also be applied to a line type liquid ejecting apparatus in which the plurality of nozzles N are distributed over the entire width of the medium M.

### C5: Modification Example 5

The liquid ejecting apparatus 100 described in the above-described embodiment may be employed in various apparatuses such as a facsimile machine and a copier, in addition to an apparatus dedicated to printing, and the application of the present disclosure is not particularly limited. Note that the application of the liquid ejecting apparatus is not limited to printing. For example, a liquid ejecting apparatus that ejects a solution of a coloring material is used as a manufacturing device that forms a color filter of a display device such as a liquid crystal display panel. In addition, a liquid ejecting apparatus that ejects a solution of a conductive material is used as a manufacturing apparatus that forms a wiring or an electrode on a wiring substrate. In addition, a liquid ejecting apparatus that ejects a solution of an organic substance related to a living body is used, for example, as a manufacturing apparatus that manufactures a biochip.

### D: Supplementary Notes

The present disclosure is summarized as follows.

Supplementary Note 1. A first aspect, which is a preferred example of a liquid ejecting apparatus of the present disclosure, the liquid ejecting apparatus including: an ejection portion having a nozzle for ejecting a liquid, a pressure chamber communicating with the nozzle, and a piezoelectric element that is driven to generate a pressure fluctuation in the liquid in the pressure chamber in response to a supplied drive signal; a drive signal generation circuit that generates the drive signal; an acquisition portion that acquires viscosity information indicating a viscosity of the liquid; and a control portion that controls an operation of the drive signal generation circuit, in which the drive signal includes an ejection pulse that ejects a droplet from the nozzle, the ejection pulse has a first contraction element that changes in potential by a first potential change amount to contract the pressure chamber, a first contraction maintaining element that is coupled to a terminal end of the first contraction element and maintains a terminal potential of the first contraction element, and a second contraction element that is coupled to a terminal end of the first contraction maintaining element and changes in potential by a second potential change amount to contract the pressure chamber, when the viscosity indicated by the viscosity information is a first viscosity, a ratio of the first potential change amount to the second potential change amount is a first value, and when the viscosity indicated by the viscosity information is a second viscosity higher than the first viscosity, the ratio of the first potential change amount to the second potential change amount is a second value smaller than the first value.

In the above aspect, by decreasing the ratio of the first potential change amount to the second potential change amount as the viscosity indicated by the viscosity information increases, it is possible to reduce a fluctuation in the ejection amount caused by an increase in the viscosity of the liquid over a wider range of viscosity changes in the liquid and suppress unstable ejection.

Supplementary Note 2. In a second aspect, which is a preferred example of the first aspect, when the viscosity indicated by the viscosity information is a third viscosity higher than the second viscosity, the ejection pulse does not have the first contraction element and the first contraction maintaining element, and has the second contraction element. In the above aspect, when the viscosity of the liquid becomes too high, unnecessary micro-vibrations are reduced, thereby making it possible to suitably suppress unstable ejection.

Supplementary Note 3. In a third aspect, which is a preferred example of the second aspect, when the viscosity indicated by the viscosity information is the third viscosity, the ejection pulse has a first expansion element that changes in potential by a third potential change amount to expand the pressure chamber before the second contraction element changes in potential, and an expansion maintaining element that maintains a terminal potential of the first expansion element from a terminal end of the first expansion element to a start end of the second contraction element. In the above aspect, it is possible to suppress a shortage in the ejection amount even when the viscosity of the liquid is higher.

Supplementary Note 4. In a fourth aspect, which is a preferred example of the third aspect, a period from start of the first expansion element to start of the first contraction element is from 0.3 times to 0.7 times a natural vibration period of the ejection portion. In the above aspect, it is possible to efficiently suppress a shortage in the ejection amount even when the viscosity of the liquid is higher.

Supplementary Note 5. In a fifth aspect, which is a preferred example of the first aspect, the ejection pulse has a first expansion element that changes in potential by a third potential change amount to expand the pressure chamber before the first contraction element changes in potential, and a first expansion maintaining element that maintains a terminal potential of the first expansion element from a terminal end of the first expansion element to a start end of the first contraction element. In the above aspect, it is possible to stabilize the meniscus of the liquid inside the nozzle immediately before ejection, and as a result, it is possible to reduce variations in the ejection amount or the ejection speed.

Supplementary Note 6. In a sixth aspect, which is a preferred example of the fifth aspect, a period from start of the first expansion element to start of the first contraction element is from 0.3 times to 0.7 times a natural vibration period of the ejection portion. In the above aspect, the liquid can be efficiently ejected.

Supplementary Note 7. In a seventh aspect, which is a preferred example of the fifth aspect, when the viscosity indicated by the viscosity information is a third viscosity higher than the second viscosity, the ejection pulse does not have the first contraction element and the first contraction maintaining element, and has the second contraction element. In the above aspect, when the viscosity of the liquid becomes too high, unnecessary micro-vibrations are reduced, thereby making it possible to suitably suppress unstable ejection.

Supplementary Note 8. In an eighth aspect, which is a preferred example of the fifth aspect, when the viscosity indicated by the viscosity information is a third viscosity higher than the second viscosity, the ejection pulse has a second expansion element that changes in potential to expand the pressure chamber before the first expansion element changes in potential, and a second expansion maintaining element that maintains a terminal potential of the second expansion element from a terminal end of the second expansion element to a start end of the first expansion element. In the above aspect, it is possible to suppress a shortage in the ejection amount even when the viscosity of the liquid is higher.

Supplementary Note 9. In a ninth aspect, which is a preferred example of any one of the first to eighth aspects, the second potential change amount when the viscosity indicated by the viscosity information is the first viscosity and the second potential change amount when the viscosity indicated by the viscosity information is the second viscosity are equal to each other. In the above aspect, it is possible to suitably reduce the fluctuations in the ejection amount caused by the increase in the viscosity of the liquid.

Supplementary Note 10. In a tenth aspect, which is a preferred example of any one of the first to ninth aspects, a period from start of the first contraction element to start of the second contraction element is from 0.3 times to 0.7 times a natural vibration period of the ejection portion. In the above aspect, the vibration caused by the first contraction element can be suitably weakened by the second contraction element. As a result, the correction width of the ejection amount based on the ratio of the first potential change amount to the second potential change amount can be increased.

Supplementary Note 11. In an eleventh aspect, which is a preferred example of any one of the first to tenth aspects, the liquid ejecting apparatus further includes a detection circuit that acquires an electric signal indicating residual vibration of the liquid in the pressure chamber after the piezoelectric element applies the pressure fluctuation to the liquid in the pressure chamber, in which the acquisition portion acquires the viscosity information based on the electric signal. In the above aspect, viscosity information can be acquired without adding an element such as a temperature sensor.

Supplementary Note 12. In a twelfth aspect, which is a preferred example of any one of the first to tenth aspects, the liquid ejecting apparatus further includes a temperature sensor that detects a temperature, in which the acquisition portion acquires the viscosity information based on the temperature detected by the temperature sensor. In the above aspect, viscosity information indicating the change in viscosity due to a change in temperature of the liquid can be directly acquired.

Supplementary Note 13. In a thirteenth aspect, which is a preferred example of any one of the first to tenth aspects, the liquid ejecting apparatus further includes a reception portion that receives an input from a user, in which the acquisition portion acquires the viscosity information based on a reception result from the reception portion. In the above aspect, viscosity information can be acquired according to the user’s desires.

What is claimed is:

1. A liquid ejecting apparatus comprising:
an ejection portion having a nozzle for ejecting a liquid, a pressure chamber communicating with the nozzle, and a piezoelectric element that is configured to be driven to generate a pressure fluctuation in the liquid in the pressure chamber in response to a supplied drive signal;
a drive signal generation circuit that is configured to generate the drive signal;
an acquisition portion that is configured to acquire viscosity information indicating a viscosity of the liquid; and
a control portion that is configured to control an operation of the drive signal generation circuit, wherein
the drive signal includes an ejection pulse that supplies to the piezoelectric element when a droplet is ejected from the nozzle,
the ejection pulse has
a first contraction element that changes in potential by a first potential change amount to contract the pressure chamber,
a first contraction maintaining element that is coupled to a terminal end of the first contraction element and maintains a terminal potential of the first contraction element, and
a second contraction element that is coupled to a terminal end of the first contraction maintaining element and changes in potential by a second potential change amount to contract the pressure chamber,
when the viscosity indicated by the viscosity information is a first viscosity, a ratio of the first potential change amount to the second potential change amount is a first value, and
when the viscosity indicated by the viscosity information is a second viscosity higher than the first viscosity, the ratio of the first potential change amount to the second potential change amount is a second value smaller than the first value.

2. The liquid ejecting apparatus according to claim 1, wherein,
when the viscosity indicated by the viscosity information is a third viscosity higher than the second viscosity, the ejection pulse does not have the first contraction element and the first contraction maintaining element, and has the second contraction element.

3. The liquid ejecting apparatus according to claim 2, wherein,
when the viscosity indicated by the viscosity information is the third viscosity,
the ejection pulse has
a first expansion element that changes in potential by a third potential change amount to expand the pressure chamber before the second contraction element changes in potential, and
an expansion maintaining element that maintains a terminal potential of the first expansion element from a terminal end of the first expansion element to a start end of the second contraction element.

4. The liquid ejecting apparatus according to claim 3, wherein
a period from start of the first expansion element to start of the first contraction element is from 0.3 times to 0.7 times a natural vibration period of the ejection portion.

5. The liquid ejecting apparatus according to claim 1, wherein,
the ejection pulse has
a first expansion element that changes in potential by a third potential change amount to expand the pressure chamber before the first contraction element changes in potential, and
a first expansion maintaining element that maintains a terminal potential of the first expansion element from a terminal end of the first expansion element to a start end of the first contraction element.

6. The liquid ejecting apparatus according to claim 5, wherein
a period from start of the first expansion element to start of the first contraction element is from 0.3 times to 0.7 times a natural vibration period of the ejection portion.

7. The liquid ejecting apparatus according to claim 5, wherein,
when the viscosity indicated by the viscosity information is a third viscosity higher than the second viscosity, the ejection pulse does not have the first contraction element and the first contraction maintaining element, and has the second contraction element.

8. The liquid ejecting apparatus according to claim 5, wherein,
when the viscosity indicated by the viscosity information is a third viscosity higher than the second viscosity,
the ejection pulse has
a second expansion element that changes in potential to expand the pressure chamber before the first expansion element changes in potential, and
a second expansion maintaining element that maintains a terminal potential of the second expansion element from a terminal end of the second expansion element to a start end of the first expansion element.

9. The liquid ejecting apparatus according to claim 1, wherein
the second potential change amount when the viscosity indicated by the viscosity information is the first viscosity and the second potential change amount when the viscosity indicated by the viscosity information is the second viscosity are equal to each other.

10. The liquid ejecting apparatus according to claim 1, wherein
a period from start of the first contraction element to start of the second contraction element is from 0.3 times to 0.7 times a natural vibration period of the ejection portion.

11. The liquid ejecting apparatus according to claim 1, further comprising:
a detection circuit that is configured to acquire an electric signal indicating residual vibration of the liquid in the pressure chamber after the piezoelectric element applies the pressure fluctuation to the liquid in the pressure chamber, wherein
the acquisition portion acquires the viscosity information based on the electric signal.

12. The liquid ejecting apparatus according to claim 1, further comprising:
a temperature sensor that configured to detect a temperature, wherein
the acquisition portion acquires the viscosity information based on the temperature detected by the temperature sensor.

13. The liquid ejecting apparatus according to claim 1, further comprising:
a reception portion that is configured to receive an input from a user, wherein
the acquisition portion acquires the viscosity information based on a reception result from the reception portion.
